(19) United States
(12) Patent Application Publication
(10) Pub. No.: US 2024/0147510 A1
(43) Pub. Date: May 2, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: SHOSUKE AOAI, TOKYO (JP); TASUKU INUI, TOKYO (JP); KOHTA HORIUCHI, TOKYO (JP)

(21) Appl. No.: 18/548,188

(22) PCT Filed: Jan. 26, 2022
(86) PCT No.: PCT/JP2022/002819

§ 371 Date: Aug. 28, 2023

(30) Foreign Application Priority Data
Mar. 5, 2021 (JP) 2021-035214

(51) Int. Cl. H04W 72/54; H04W 52/02; H04W 72/12

(52) U.S. Cl. CPC H04W 72/54; H04W 52/0261; H04W 72/12

(57) ABSTRACT

An information processing apparatus (CU) includes a processing unit (20). A processing unit (20) selects one communication unit (10) from a plurality of communication units (10) having different communication schemes based on schedule information (51) and time information.

### FIELD

The present invention relates to an information processing apparatus, an information processing method, and a program.

### BACKGROUND

In recent years, the communication capacity that can be transmitted and received using a wireless communication system has increased, and the fifth generation mobile communication system (5G) has recently started to be put into practical use. In addition to such a background, recently, a way of working regardless of a place such as remote work has been expanded in business, and a communication capacity via wireless communication for use in TV conference or remote control tends to increase.

In general, a communication unit having a large communicable capacity consumes a large amount of power, and in the case of remote work, there is a case where the communication unit is not in an environment where power supply can be always received. Therefore, a system that provides an optimal communication environment while suppressing power consumption is required.

### CITATION LIST

### Patent Literature

Patent Literature 1: JP 2016-32160 A

### SUMMARY

### Technical Problem

Patent Literature 1 discloses that which communication unit having different power consumption (communication capacity) is used is selected according to information regarding an operation time of the communication unit and a determination result as to whether or not a (predicted) remaining battery level when communicating the same operation with a certain communication unit reaches a predetermined threshold value. However, it cannot be said that an appropriate communication unit can be selected only by the information on the operation time, and it cannot be said that power consumption can be appropriately suppressed.

Therefore, the present disclosure proposes an information processing apparatus, an information processing method, and a program capable of providing an optimal communication environment while suppressing power consumption.

### Solution to Problem

According to the present disclosure, an information processing apparatus is provided that comprises a processing unit that selects one communication unit from a plurality of communication units having different communication schemes based on schedule information and time information. According to the present disclosure, an information processing method in which an information process of the information processing apparatus is executed by a computer, and a program for causing the computer to execute the information process of the information processing apparatus, are provided.

### BRIEF DESCRIPTION OF DRAWINGS

FIG. 1 is a diagram illustrating an example of a network environment.

FIG. 2 is a diagram illustrating an example of a configuration of the communication unit.

FIG. 3 is a flowchart illustrating an example of an information processing method performed by the communication unit.

FIG. 4 is a diagram illustrating a specific example of switching control of the communication unit according to an actual schedule.

FIG. 5 is a block diagram illustrating a hardware configuration example of the communication unit.

### DESCRIPTION OF EMBODIMENTS

Hereinafter, embodiments of the present disclosure will be described in detail with reference to the drawings. In each of the following embodiments, the same parts are denoted by the same reference signs, and redundant description will be omitted.

Note that the description will be given in the following order.
[1. Communication network]
[2. Configuration of communication unit]
[3. Information processing method]
[4. Hardware configuration example]
[5. Effects]
[6. Modification example]

### [1. Communication Network]

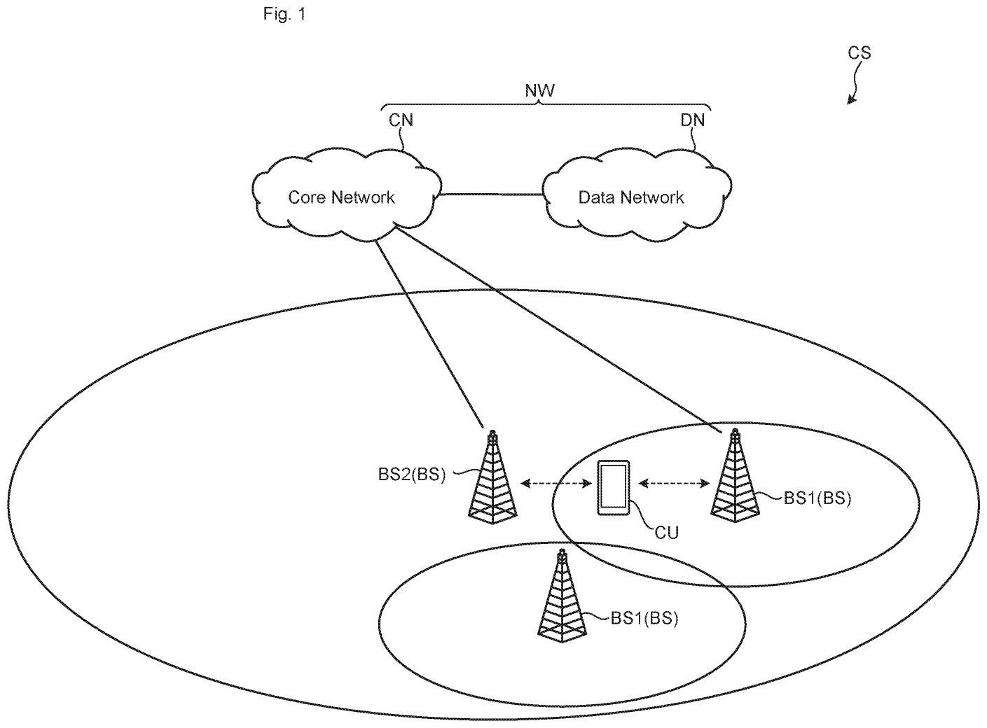

FIG. 1 is a diagram illustrating an example of a network environment used in the present disclosure.

In recent years, specifications of 5G-NR, which is a next-generation wireless communication system, have been studied in the third generation partnership project (3GPP). Specifically, in the 5G-NR, a high speed and large capacity (enhanced mobile broadband (eMBB)), multiple access (massive machine type communication (mMTC)), and low delay and high reliability (ultra-reliable and low latency communications (URLLC)) are included as the scope of standardization.

In particular, in order to realize high-speed communication in the eMBB, it is necessary to extend a frequency band used for wireless communication. Therefore, in the 5G-NR, for example, use of a high frequency band represented by a millimeter wave band has been studied. Specifically, in the 5G-NR, a frequency band definition enabling allocation to 24 GHz or more has been added. In a case where a high frequency band is used, it is possible to perform communication at a higher speed than in a case of a frequency band that has been used before.

Meanwhile, when frequency bands used for communication are different, radio wave characteristics change. For example, in a case where communication using a high frequency band is performed, transmission power is higher than that in a frequency band used in a wireless communication system of 4G or earlier, and thus power consumption at the time of transmitting a radio wave signal increases. Furthermore, for example, in a case where communication using a high frequency band is performed, it is assumed that a modem processing load of a terminal device increases, and consequently power consumption increases as compared with other frequency bands.

On the other hand, depending on a data amount of the cellular communication executed by the terminal device, a speed equivalent to the communication speed in the case of using the high frequency band may not always be required. For example, since an amount of data to be communicated is small in transmission and reception of a text message, it is assumed that there is no problem even if the communication speed is not high using a high frequency band.

In view of the above points, it is desired to reduce power consumption by determining a frequency band according to a state of the terminal device and the purpose of communication.

Therefore, a communication unit CU according to an embodiment of the present disclosure has a function of determining a frequency band (communication scheme) to be used for communication on the basis of a state of the communication unit CU. According to this configuration, communication suitable for the state of the own device can be performed, and power consumption can be suppressed according to the state.

FIG. 1 illustrates a communications system CS including the communication unit CU, a plurality of base stations BS, and a network NW. The plurality of base stations BS includes, for example, a 5GNR base station BS1 and an LTE base station BS2. Hereinafter, an example in which a communication scheme is selected between 4G/LTE and 5G will be described. In the 5G-NR communication system, for example, a non-standalone (NSA) scheme is adopted. The NSA scheme is a scheme of using a long term evolution (LTE) line in implementing 5G-NR communication. Specifically, the NSA scheme is a scheme of transmitting and receiving a control signal through the LTE line and transmitting and receiving a data signal through a 5G-NR line.

On the other hand, a technique according to the present disclosure can also be applied to a standard alone (SA) scheme of the 5G-NR communication system. The SA scheme is a scheme in which transmission and reception of both a control signal and a data signal are performed in the 5G-NR line. Of course, the 5G-NR communication system communication is merely an example, and the present technique can be applied to other communication systems.

The 5GNR base station BS1 is a base station that provides 5G-NR wireless communication. The 5GNR base station BS1 is connected to a core network CN. Here, the core network CN is connected to a data network DN via a gateway device (not illustrated). Furthermore, a cell of the 5GNR base station BS1 may be in a smaller range than a cell of the LTE base station BS2.

The communication unit CU is connected to the 5GNR base station BS1 or the LTE base station BS2 to enjoy a wireless communication service. The communication unit CU may be, for example, a smartphone. Note that the communication unit CU transmits and receives a control signal to and from the LTE base station BS2, and transmits and receives a data signal to and from the 5GNR base station BS1.

The communication unit CU determines a frequency band to be used for communication from a plurality of independent frequency bands (communication schemes) on the basis of information related to the own device. Here, the information related to the own device refers to, for example, information related to processing scheduled to be performed by the own device. The communication unit CU selects, for each schedule item, an appropriate communication scheme according to communication performance required in implementation of the schedule item.

The LTE base station BS2 is a base station that provides LTE radio communication. The LTE base station BS2 is connected to the core network CN similarly to the 5GNR base station BS1.

### [2. Configuration of Communication Unit]

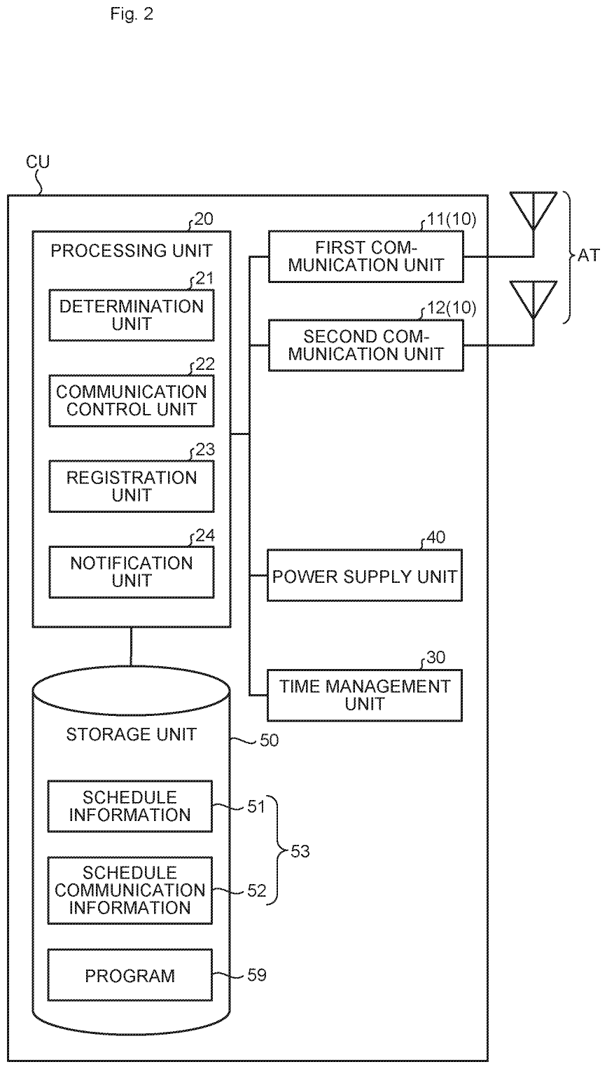

FIG. 2 is a diagram illustrating an example of a configuration of the communication unit CU.

The communication unit CU is an information processing apparatus that processes various types of information. The communication unit CU can perform processing for each schedule item on the basis of schedule information 51. The communication unit CU includes, for example, a plurality of communication units 10, an antenna unit AT, a processing unit 20, a time management unit 30, a power supply unit 40, and a storage unit 50.

The plurality of communication units 10 adopt different communication schemes. The plurality of communication units 10 include, for example, a first communication unit 11 and a second communication unit 12. The first communication unit 11 adopts a communication scheme such as 5G having a large communication capacity (communication speed) and large power consumption. The second communication unit 12 adopts a communication scheme such as 4G/LTE in which a communication capacity and power consumption are smaller than those of the first communication unit 11. In general, as the communication capacity increases, communication performance increases, but power consumption also increases. The communication performance and the power consumption are in a trade-off relationship. Each of the communication units 10 transmits and receives images, audio information, and the like to and from an external device via the antenna unit AT.

The processing unit 20 provides various functions of the communication unit CU. The processing unit 20 includes, for example, a determination unit 21, a communication control unit 22, a registration unit 23, and a notification unit 24.

Based on schedule-related information 53 acquired from the storage unit 50, time information acquired from the time management unit 30, external power supply information acquired from the power supply unit 40, and the like, the determination unit 21 determines which communication scheme should be used for communication. The communication control unit 22 controls the communication unit 10 corresponding to the communication scheme determined by the determination unit 21 to perform communication.

The schedule-related information 53 includes various information related to the schedule. For example, the schedule-related information 53 includes schedule information 51 and schedule communication information 52.

The schedule information 51 includes information regarding the schedule of a user registered in the communication unit CU. The schedule information 51 may be information recorded in the communication unit CU or information acquired from an external server using a schedule management application or the like. The schedule information 51 may include at least information regarding the schedule for the current day. For example, the determination unit 21 selects one communication unit 10 from the plurality of communication units 10 having different communication schemes on the basis of the schedule information 51 and the time information. As a result, the communication unit 10 having appropriate communication performance according to the schedule is selected. Therefore, power consumption can be suppressed while securing sufficient communication quality.

The schedule communication information 52 is information indicating a correspondence relationship between schedule items and required communication performance. The required communication performance includes, for example, performance related to a communication capacity and an allowable delay amount. A plurality of schedule items is registered in the schedule communication information 52. In the schedule communication information 52, the required communication performance is registered for each schedule item. For example, the determination unit 21 selects the communication unit 10 on the basis of the schedule communication information 52 in which the required communication performance for each schedule item is registered. According to this configuration, it is possible to select an appropriate communication unit for each schedule item.

For example, an allowable delay amount in a bidirectional conference such as a television conference is about 500 ms. A requested delay amount required for unilaterally viewing a moving image, listening to a lecture on the Web, or the like is larger than the allowable delay amount required in the bidirectional conference. Therefore, in the case of the schedule in which the requested delay amount is not high, the power consumption can be suppressed by using the communication unit 10 having low communication performance but low power consumption.

Note that the required communication performance may be set in advance by the user, but may be estimated on the basis of communication information acquired in an implementation period of the past schedule item, an action history of the user, and the like. For example, the communication capacity registered as the required communication performance can be estimated from the past average communication capacity, a relationship with the application to be used, and the like. Alternatively, the past setting information of the user and the communication information (communication capacity) at that time may be learned, and the required communication performance may be updated as needed on the basis of the learning result.

The schedule communication information 52 can include information indicating a use start timing of the communication unit for each schedule item. For example, in a case where the schedule has a partner such as a meeting, there is a case where a delay in communication immediately after switching of the communication unit 10 is not allowed. In that case, it is preferable to switch the communication unit 10 a predetermined time before the start time of the schedule. In the case of work that does not require a partner, communication delay immediately after switching may be allowed. In this case, the communication unit 10 may be switched at the timing when the start time of the schedule comes. When the switching control is performed just at the scheduled time, there is a possibility that a delay occurs due to the switching of the communication unit 10. In that case, sufficient communication quality is secured by switching the communication unit 10 in advance.

The time management unit 30 manages time information of the current communication unit CU. The time management unit 30 may periodically communicate with an external server to perform time synchronization.

The power supply unit 40 manages a battery of the communication unit CU. The power supply unit 40 notifies the processing unit 20 of a remaining power supply capacity. Furthermore, the power supply unit 40 notifies the processing unit 20 of external power supply information regarding connection to an external power supply. The durability of the battery is estimated by the external power supply information. For example, the determination unit 21 determines whether or not switching of the communication unit 10 is possible on the basis of the external power supply information.

The external power supply information includes information (connection information) regarding a state of connection between the communication unit CU and the external power supply, and information (connection environment information) indicating a connectability to the external power supply. The connection information is information indicating whether or not the communication unit CU is currently connected to the external power supply. The connection environment information is information indicating whether or not the communication unit CU is currently in an environment where the communication unit CU can be connected to the external power supply.

For example, when determining that the communication unit CU is currently connected to the external power supply on the basis of the connection information, the determination unit 21 determines that switching of the communication unit 10 is unnecessary. Even in a case where it is determined that the communication unit CU is currently connected to the external power supply and the remaining battery capacity is more than or equal to a predetermined value, the determination unit 21 determines that switching of the communication unit 10 is unnecessary. Furthermore, the determination unit 21 detects position information regarding the current location of the communication unit CU on the basis of sensor information detected by a GPS sensor or the like. The determination unit 21 determines whether or not the communication unit CU is in an environment (such as an office) where the communication unit CU can be connected to an external power supply on the basis of the position information of the communication unit CU.

The determination unit 21 monitors the implementation status of the schedule item included in the schedule information 51. When detecting the information indicating that the implementation of the schedule item has ended, the determination unit 21 selects the communication unit 10 on the basis of the next schedule of the ended schedule item. For example, the determination unit 21 can switch the communication unit 10 on the basis of information indicating that the schedule has ended regardless of the current time (information indicating operation of an exit button of the conference, operation of closing the application, or the like). As a result, for example, in a case where the conference ends earlier than scheduled, the power consumption can be suppressed by switching the communication unit 10 to a communication unit having low communication performance. Furthermore, in a case where the conference takes longer than scheduled, the communication quality can be sufficiently secured by not switching the communication unit 10.

The registration unit 23 determines the required communication performance of an unregistered schedule item not registered in the schedule communication information 52 on the basis of the communication information (communication capacity) acquired during the implementation period of the unregistered schedule item or the action history of the user (for example, the user manually switches the communication scheme). The registration unit 23 registers the determined required communication performance in the schedule communication information 52 in association with the unregistered schedule item.

The registration unit 23 updates the required communication performance registered in the schedule communication information 52 on the basis of a learning result of the past communication information (communication capacity). For example, it is assumed that a schedule set with a specific schedule item name is work for remotely operating an external device, and the registered required communication performance is communication performance compatible with 4G/LTE. In a case where the registration unit 23 determines, from the communication result of the schedule set with the same schedule item name in the past, that the schedule corresponding to this schedule item name requires a communication capacity of a predetermined capacity or more, the registration unit corrects the required communication performance of the schedule item corresponding to this schedule item name to the communication performance corresponding to 5G.

In a case where the communication unit 10 in use is to be switched to another communication unit 10 on the basis of the selection result, the notification unit 24 notifies the user of whether or not switching is possible before switching the communication unit 10. For example, in a case where another schedule is set before the schedule that requires switching of the communication unit 10, or in a case where it is detected that the communication work is being performed on the communication unit 10 before the switching, the notification unit 24 notifies the user before the switching of the communication unit 10. As a result, switching of the communication unit 10 can be urged at an appropriate timing without hindering work to the user.

The storage unit 50 stores, for example, the schedule information 51, the schedule communication information 52, and a program 59 executed by the processing unit 20. The program 59 is a program that causes a computer to execute information processing according to the present disclosure. The processing unit 20 performs various processing in accordance with the program 59 stored in the storage unit 50. The storage unit 50 may be used as a work area for temporarily storing a processing result of the processing unit 20. The storage unit 50 includes, for example, an arbitrary non-transitory storage medium such as a semiconductor storage medium and a magnetic storage medium. The storage unit 50 includes, for example, an optical disk, a magneto-optical disk, or a flash memory. The program 59 is stored in, for example, a non-transitory computer-readable storage medium.

The processing unit 20 is, for example, a computer including a processor and a memory. The memory of the processing unit 20 includes a random access memory (RAM) and a read only memory (ROM). The processing unit 20 functions as the determination unit 21, the communication control unit 22, the registration unit 23, and the notification unit 24 by executing the program 59.

### [3. Information Processing Method]

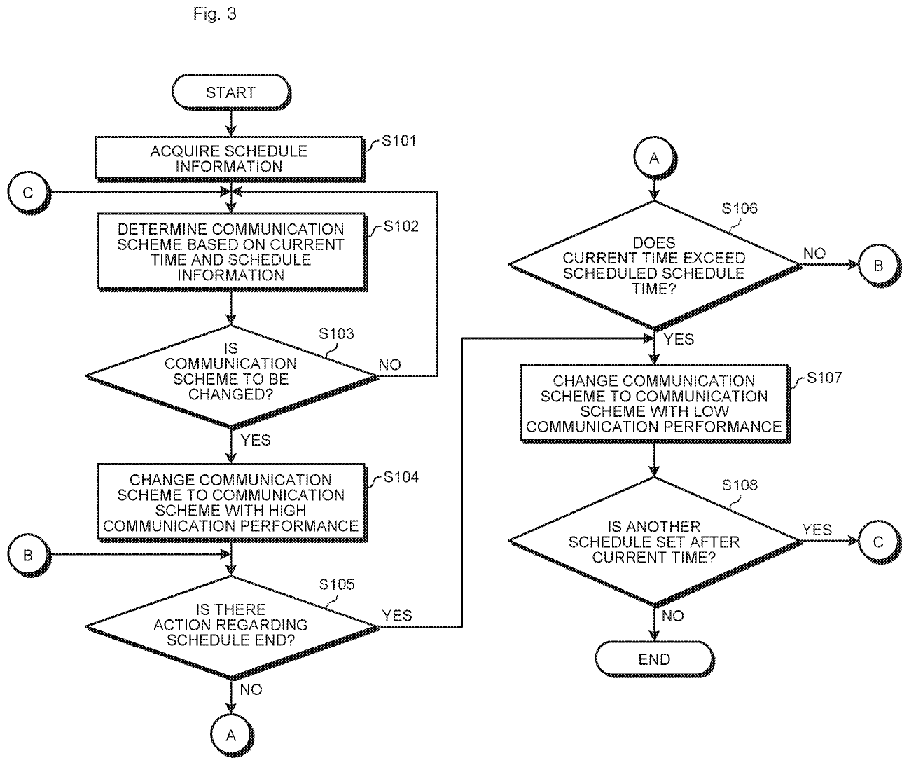

FIG. 3 is a flowchart illustrating an example of an information processing method performed by the communication unit CU. In the communication unit CU, for example, a communication scheme (the second communication unit 12) with low communication performance is adopted as a default communication scheme.

In step S101, the determination unit 21 acquires the schedule information 51 indicating at least the schedule of the user on that day from the storage unit 50. In step S102, the determination unit 21 determines a communication scheme to be currently set from the current time information and the acquired schedule information 51. A timing of switching the communication scheme may be a timing at which a schedule requiring high communication performance is scheduled, or may be a timing a predetermined time before this schedule is set (for example, two or three minutes before).

In step S103, the determination unit 21 determines whether to change the communication scheme from the determination result in S102. In a case where it is determined in step S103 that the communication scheme is changed (step S103: Yes), the process proceeds to step S104. In a case where it is determined in step S103 that the communication scheme is not changed (step S103: No), the process returns to step S102, and the above-described processing is repeated until it is determined that the communication scheme is changed.

In step S104, the determination unit 21 changes the communication scheme to a scheme with high communication performance (large power consumption). The communication control unit 22 controls the communication unit 10 (first communication unit 11) corresponding to the changed communication scheme to perform communication.

In step S105, the determination unit 21 determines whether or not there is information regarding schedule end. In a case where it is determined in step S105 that there is information regarding the schedule end (step S105: Yes), the process proceeds to step S107. In step S105, in a case where it is determined that there is no information regarding the schedule end (step S105: No), the process proceeds to step 5106.

In step S106, the determination unit 21 determines whether it is time to end the schedule. In a case where it is determined in step S106 that it is time to end the schedule (step S106: Yes), the process proceeds to step S107. In a case where it is determined in step S106 that it is not time to end the schedule (step S106: No), the process returns to step S105, and the above-described processing is repeated until it is determined that it is time to end the schedule.

Note that, in a case where it is time to end the schedule, the notification unit 24 may notify the user in advance that the communication scheme is to be changed, and the process may proceed to step S107 upon receiving a response, instead of changing the communication scheme suddenly. In a case where the conference is long, changing the communication scheme suddenly may interfere with the conference. In that case, by notifying the user about whether or not switching of the communication scheme is possible, the user can recognize that the switching time of the communication scheme has come, and can determine whether or not switching of the communication scheme is possible.

In step S107, the determination unit 21 changes the communication scheme to a scheme with low communication performance (low power consumption). The communication control unit 22 controls the communication unit 10 (second communication unit 12) corresponding to the changed communication scheme to perform communication.

In step S108, the determination unit 21 determines whether another schedule is set up after the current time. In step S108, in a case where it is determined that another schedule is set after the current time (step S108: Yes), the process returns to step S102, and the above-described processing is repeated. In step S108, in a case where it is determined that no other schedule is set after the current time (step S108: No), the determination unit 21 ends the processing.

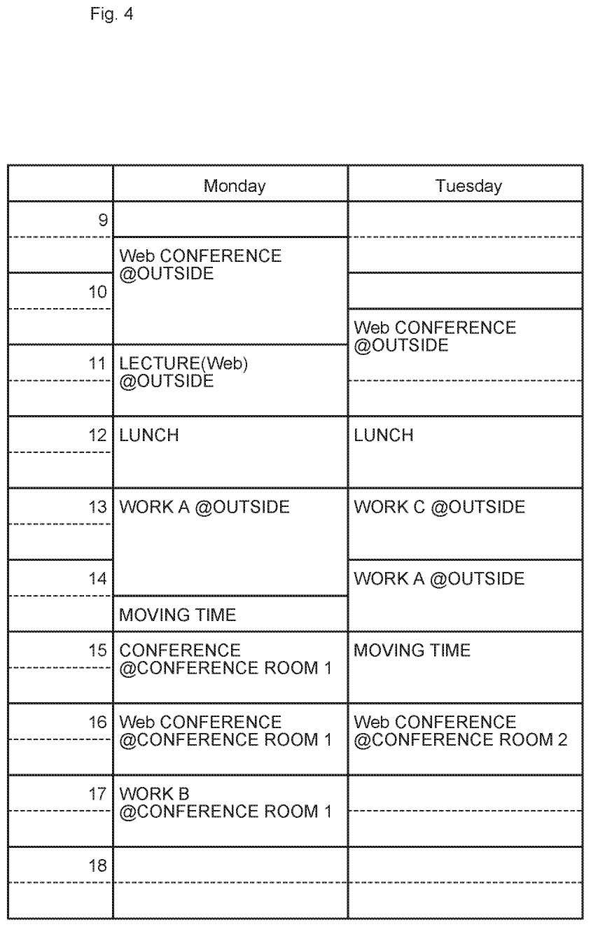

FIG. 4 is a diagram illustrating a specific example of switching control of the communication unit 10 based on an actual schedule. FIG. 4 illustrates a schedule of Monday and Tuesday as an example of the schedule. In the communication unit CU, for example, a communication scheme (the second communication unit 12) with low communication performance is adopted as a default communication scheme.

### <<Monday>>

<9:28: Second Communication Unit 12→First Communication Unit 11>

From 9:30, a Web conference (a schedule requiring a communication capacity larger than a predetermined value) is scheduled at a place outside the office or house (where power supply connection is not available). Therefore, the determination unit 21 switches from the second communication unit 12 to the first communication unit 11 having high communication performance (high power consumption).

### <10:45: First Communication Unit 11→Second Communication Unit 12>

The determination unit 21 acquires conference end information (information indicating the operation of an end button, and the like) indicating the end of the conference. The determination unit 21 switches from the first communication unit 11 to the second communication unit 12 on the basis of the conference end information. A lecture via the Web is scheduled from 11:00, but communication from the user is only chatting with a question box, and high delay requirement accuracy is not required. Therefore, the determination unit 21 maintains the current communication scheme (second communication unit 12).

### <13:00: Second Communication Unit 12→First Communication Unit 11>

Work A requiring communication with an external device is scheduled. At this point, because of the work that has not been registered in the past, the determination unit 21 maintains the current communication scheme (second communication unit 12). However, a communication capacity larger than a predetermined capacity is required by remote work, and the user manually switches from the second communication unit 12 to the first communication unit 11.

The registration unit 23 registers the required communication performance of the work A in the schedule communication information 52 on the basis of the communication capacity required for the work A or the action history of the user (the result of manual switching of the communication unit 10 by the user). The registration unit 23 stores the updated schedule communication information 52 in the storage unit 50. Thereafter, the first communication unit 11 is automatically selected by the determination unit 21 for the work A.

### <15:00: Second Communication Unit 12>

A normal meeting (not a schedule requiring a communication capacity larger than a predetermined capacity) is scheduled. Therefore, the determination unit 21 maintains the current communication scheme (second communication unit 12).

### <15:58: Second Communication Unit 12→First Communication Unit 11>

A Web conference (a schedule requiring a communication capacity larger than a predetermined capacity) is scheduled. Therefore, the determination unit 21 switches from the second communication unit 12 to the first communication unit 11.

### <16:55: First Communication Unit 11>

The determination unit 21 acquires information indicating the end of the conference. However, since the determination unit 21 determines that a position of the own device specified from the position information is a power supply connectable location, the current communication scheme (the first communication unit 11) is maintained.

### <17:00: First Communication Unit 11>

The registration unit 23 determines the required communication performance of work B from the communication capacity required for the work B, and registers the required communication performance in the schedule communication information 52. The registration unit 23 stores the updated schedule communication information 52 in the storage unit 50. For example, in a case where the communication capacity of the work B is small and the second communication unit 12 can cope with the work B, the registration unit 23 registers the required communication performance of the work B as the communication performance corresponding to the second communication unit 12.

### <<Tuesday>>

### <10:28: Second Communication Unit 12→First Communication Unit 11>

A Web conference (a schedule requiring a communication capacity larger than a predetermined value) is scheduled at a place outside the office or house (where power supply connection is not available) from 10:30. Therefore, the determination unit 21 switches from the second communication unit 12 to the first communication unit 11.

### <11:59: First Communication Unit 11→Second Communication Unit 12>

The determination unit 21 acquires conference end information indicating the end of the conference. The determination unit 21 switches from the first communication unit 11 to the second communication unit 12 on the basis of the conference end information.

### <13:00: Second Communication Unit 12>

The schedule of work C is scheduled. A communication capacity of the work C is a communication capacity that can also be supported by the second communication unit 12. During an implementation period of the work C, the manual switching operation of the communication unit 10 by the user is not performed.

The registration unit 23 registers the required communication performance of the work C in the schedule communication information 52 on the basis of the communication capacity required for the work C or the manual switching result of the communication unit 10 by the user. The registration unit 23 stores the updated schedule communication information 52 in the storage unit 50. Thereafter, the second communication unit 12 is automatically selected by the determination unit 21 for the work C.

### <14:00: Second Communication Unit 12→First Communication Unit 11>

Since the start time of the work A has come, the determination unit 21 switches from the second communication unit 12 to the first communication unit 11.

### <15:00: First Communication Unit 11→Second Communication Unit 12>

Since the schedule end time of the work A has come, the determination unit 21 notifies the user via the notification unit 24 that the first communication unit 11 is switched to the second communication unit 12. The determination unit 21 switches from the first communication unit 11 to the second communication unit 12 upon receiving the user's consent to the notification.

### <15:58: Second Communication Unit 12→First Communication Unit 11>

A Web conference (a schedule requiring a communication capacity larger than a predetermined capacity) is scheduled. Therefore, the determination unit 21 switches from the second communication unit 12 to the first communication unit 11.

Note that, in a case where the communication unit 10 is to be switched together with the end of each work, the determination unit 21 may once transmit a notification to the user via the notification unit 24, and execute switching of the communication scheme after receiving consent of switching for the notification. The work is incorporated into the schedule, but it does not necessarily end as scheduled, and there are cases where it increases more than expected. By performing the notification as described above, it is possible to prevent the communication unit 10 from being switched without permission and becoming an obstacle to the work.

### [4. Hardware Configuration Example]

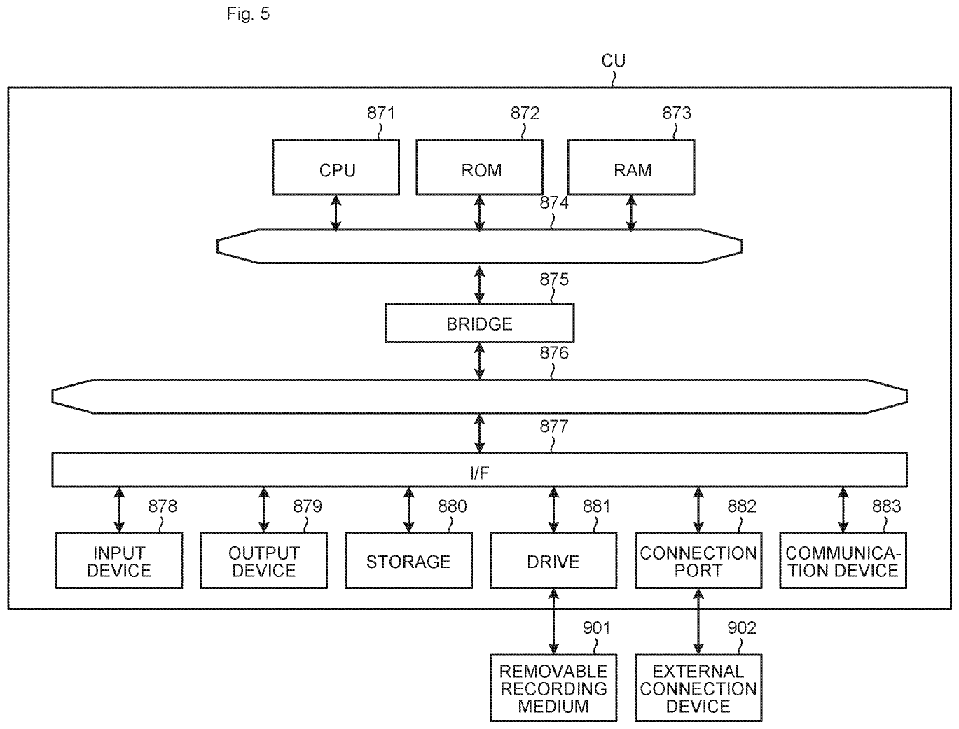

FIG. 5 is a block diagram illustrating a hardware configuration example of the communication unit CU.

The communication unit CU includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the components may be omitted. Furthermore, components other than the components illustrated here may be further included.

The processor 871 functions as, for example, an arithmetic processing device or a control device, and controls an overall operation of each component or a part thereof on the basis of various programs recorded in the ROM 872, the RAM 873, the storage 880, or a removable recording medium 901.

The ROM 872 is a unit that stores a program read by the processor 871, data used for calculation, and the like. The RAM 873 temporarily or permanently stores, for example, a program read by the processor 871, various parameters that appropriately change when the program is executed, and the like.

The processor 871, the ROM 872, and the RAM 873 are mutually connected via, for example, the host bus 874 capable of high-speed data transmission. On the other hand, the host bus 874 is connected to the external bus 876 having a relatively low data transmission speed via the bridge 875, for example. Furthermore, the external bus 876 is connected to various components via the interface 877.

As the input device 878, for example, a mouse, a keyboard, a touch panel, a button, a switch, a lever, and the like are used. Moreover, as the input device 878, a remote controller (hereinafter, remote controller) capable of transmitting a control signal using infrared rays or other radio waves may be used. Furthermore, the input device 878 includes a voice input device such as a microphone.

The output device 879 is a device capable of visually or audibly notifying the user of acquired information, for example, a display device such as a cathode ray tube (CRT), an LCD, or an organic EL, an audio output device such as a speaker or a headphone, a printer, a mobile phone, a facsimile, or the like. Furthermore, the output device 879 according to the present disclosure includes various vibration devices capable of outputting tactile stimulation.

The storage 880 is a device for storing various data. As the storage 880, for example, a magnetic storage device such as a hard disk drive (HDD), a semiconductor storage device, an optical storage device, a magneto-optical storage device, or the like is used.

The drive 881 is, for example, a device that reads information recorded in the removable recording medium 901 such as a magnetic disk, an optical disk, a magneto-optical disk, or a semiconductor memory, or writes information to the removable recording medium 901.

The removable recording medium 901 is, for example, a DVD medium, a Blu-ray (registered trademark) medium, an HD DVD medium, various semiconductor storage media, or the like. Of course, the removable recording medium 901 may be, for example, an IC card on which a non-contact IC chip is mounted, an electronic device, or the like.

The connection port 882 is a port for connecting an external connection device 902 such as a universal serial bus (USB) port, an IEEE1394 port, a small computer system interface (SCSI), an RS-232C port, or an optical audio terminal.

The external connection device 902 is, for example, a printer, a portable music player, a digital camera, a digital video camera, an IC recorder, or the like.

The communication device 883 is a communication device for connecting to a network, and is, for example, a communication card for wired or wireless LAN, Bluetooth (registered trademark), or wireless USB (WUSB), a router for optical communication, a router for asymmetric digital subscriber line (ADSL), a modem for various communications, or the like.

Furthermore, the communication device 883 includes a communication interface that supports a wireless communication scheme such as 5G-NR, LTE, or LTE-Advanced. Specifically, the communication device 883 may include a baseband processor that performs signal processing such as encoding, decoding, and modulation/demodulation. Furthermore, the communication device 883 may include an RF circuit. Furthermore, the communication device 883 may include an antenna that radiates a radio wave into space and converts a radio wave in space into a signal.

### [5. Effects]

The communication unit CU includes a processing unit 20. The processing unit 20 selects one communication unit 10 from the plurality of communication units 10 having different communication schemes on the basis of the schedule information 51 and the time information. In the information processing method of the present embodiment, the processing of the communication unit CU described above is executed by a computer. The program 59 according to the present embodiment causes a computer to implement the processing of the communication unit CU described above.

According to this configuration, it is possible to suppress power consumption while securing sufficient communication quality.

The processing unit 20 selects the communication unit 10 on the basis of the schedule communication information 52 in which the required communication performance for each schedule item is registered.

According to this configuration, the appropriate communication unit 10 is selected for each schedule item.

The processing unit 20 determines the required communication performance of an unregistered schedule item not registered in the schedule communication information 52 on the basis of the communication information acquired during the implementation period of the unregistered schedule item or the action history of the user. The processing unit 20 registers the determined required communication performance in the schedule communication information 52 in association with the unregistered schedule item.

According to this configuration, the required communication performance of the unregistered schedule item is appropriately set according to the actual communication status in the implementation period of the unregistered schedule item.

The required communication performance includes performance related to a communication capacity or an allowable delay amount.

According to this configuration, the appropriate communication unit 10 is selected on the basis of the communication capacity and the allowable delay amount.

The schedule communication information 52 includes information indicating the use start timing of the communication unit 10 for each schedule item.

According to this configuration, the selected communication unit 10 can be started to be used at an appropriate timing for each schedule item.

The processing unit 20 determines whether or not switching of the communication unit 10 is possible on the basis of the information regarding the state of connection to the external power supply or the information indicating the connectability to the external power supply.

According to this configuration, the durability of the battery is estimated based on the state of connection to the external power supply or the connectability to the external power supply. By comparing the power consumption amount in each communication unit 10 with the sustainability of the battery, an appropriate communication unit 10 according to the sustainability of the battery is selected.

The processing unit 20 determines that it is not necessary to switch the communication unit 10 in a situation where the battery has high sustainability. For example, in a case where it is determined, on the basis of the information regarding the state of connection, that the communication unit CU is currently connected to the external power supply, or in a case where it is determined that the communication unit CU is currently connected to the external power supply and the remaining battery capacity is a predetermined value or more, the processing unit 20 determines that the switching of the communication unit 10 is unnecessary.

According to this configuration, the switching control of the communication unit 10 is simplified.

In a case where the communication unit 10 in use is to be switched to another communication unit 10 on the basis of the selection result, the processing unit 20 notifies the user of whether or not switching is possible before switching the communication unit 10.

According to this configuration, it is possible to suppress occurrence of trouble in the work performed before the switching due to the switching of the communication unit 10.

The processing unit 20 monitors the implementation status of the schedule item included in the schedule information 51. In a case where the processing unit 20 detects information indicating that the implementation of the schedule item has ended, the communication unit 10 is selected on the basis of the next schedule of the ended schedule item.

According to this configuration, even in a case where the schedule ends at a timing deviated from the scheduled time, switching of the communication unit 10 is appropriately performed in accordance with the end timing of the actual schedule.

Note that the effects described in the present specification are merely examples and are not limited, and other effects may be provided.

### [6. Modification Example]

In the above-described embodiment, 5G and 4G/LTE are exemplified as combinations of communication schemes having different communication performances. Although the communication scheme is switched between 5G and 4G/LTE, the combination of the communication schemes is not limited thereto. The communication scheme may be switched between wireless fidelity (Wi-Fi (registered trademark)) and 3G.

### Supplementary Note

Note that the present technique can also have the following configurations.

(1)

An information processing apparatus comprising a processing unit that selects one communication unit from a plurality of communication units having different communication schemes based on schedule information and time information.

(2)

The information processing apparatus according to (1), wherein
the processing unit selects the communication unit based on schedule communication information in which required communication performance for each schedule item is registered.
   (3)

The information processing apparatus according to (2), wherein
the processing unit determines required communication performance of an unregistered schedule item not registered in the schedule communication information based on communication information acquired during an implementation period of the unregistered schedule item, and registers the determined required communication performance in the schedule communication information in association with the unregistered schedule item.
   (4)

The information processing apparatus according to (2), wherein
the processing unit determines required communication performance of an unregistered schedule item not registered in the schedule communication information based on an action history of a user acquired during an implementation period of the unregistered schedule item, and registers the determined required communication performance in the schedule communication information in association with the unregistered schedule item.
   (5)

The information processing apparatus according to any one of (2) to (4), wherein
the required communication performance includes performance related to a communication capacity.
   (6)

The information processing apparatus according to any one of (2) to (4), wherein
the required communication performance includes performance related to an allowable delay amount.
   (7)

The information processing apparatus according to any one of (2) to (6), wherein
the schedule communication information includes information indicating a use start timing of the communication unit for each schedule item.
   (8)

The information processing apparatus according to any one of (1) to (7), wherein
the processing unit determines whether or not switching of the communication unit is possible based on information regarding a state of connection to an external power supply.
   (9)

The information processing apparatus according to (8), wherein
the processing unit determines that switching of the communication unit is unnecessary when it is determined that the information processing apparatus is currently connected to the external power supply based on the information regarding the state of connection.
   (10)

The information processing apparatus according to (8), wherein
the processing unit determines that switching of the communication unit is unnecessary when it is determined that the information processing apparatus is currently connected to the external power supply and a remaining battery capacity is more than or equal to a predetermined value based on the information regarding the state of connection.
   (11)

The information processing apparatus according to any one of (1) to (7), wherein
the processing unit determines whether or not switching of the communication unit is possible based on information indicating a connectability to an external power supply.
   (12)

The information processing apparatus according to any one of (1) to (11), wherein
when the communication unit being used is to be switched to another communication unit based on a selection result, the processing unit notifies a user of whether or not switching is possible before switching the communication unit.
   (13)

The information processing apparatus according to any one of (1) to (12), wherein
the processing unit monitors an implementation status of a schedule item included in the schedule information and, when detecting information indicating that implementation of the schedule item has ended, selects the communication unit based on a next schedule of the ended schedule item.
   (14)

An information processing method executed by a computer, the method comprising selecting one communication unit from a plurality of communication units having different communication schemes based on schedule information and time information.

(15)

A program for causing a computer to select one communication unit from a plurality of communication units having different communication schemes based on schedule information and time information.

### REFERENCE SIGNS LIST

10 COMMUNICATION UNIT
20 PROCESSING UNIT
51 SCHEDULE INFORMATION
52 SCHEDULE COMMUNICATION INFORMATION
CU COMMUNICATION UNIT (INFORMATION PROCESSING APPARATUS)

1. An information processing apparatus comprising a processing unit that selects one communication unit from a plurality of communication units having different communication schemes based on schedule information and time information.

2. The information processing apparatus according to claim 1, wherein
the processing unit selects the communication unit based on schedule communication information in which required communication performance for each schedule item is registered.

3. The information processing apparatus according to claim 2, wherein
the processing unit determines required communication performance of an unregistered schedule item not registered in the schedule communication information based on communication information acquired during an implementation period of the unregistered schedule item, and registers the determined required communication performance in the schedule communication information in association with the unregistered schedule item.

4. The information processing apparatus according to claim 2, wherein
the processing unit determines required communication performance of an unregistered schedule item not registered in the schedule communication information based on an action history of a user acquired during an implementation period of the unregistered schedule item, and registers the determined required communication performance in the schedule communication information in association with the unregistered schedule item.

5. The information processing apparatus according to claim 2, wherein
the required communication performance includes performance related to a communication capacity.

6. The information processing apparatus according to claim 2, wherein
the required communication performance includes performance related to an allowable delay amount.

7. The information processing apparatus according to claim 2, wherein
the schedule communication information includes information indicating a use start timing of the communication unit for each schedule item.

8. The information processing apparatus according to claim 1, wherein
the processing unit determines whether or not switching of the communication unit is possible based on information regarding a state of connection to an external power supply.

9. The information processing apparatus according to claim 8, wherein
the processing unit determines that switching of the communication unit is unnecessary when it is determined that the information processing apparatus is currently connected to the external power supply based on the information regarding the state of connection.

10. The information processing apparatus according to claim 8, wherein
the processing unit determines that switching of the communication unit is unnecessary when it is determined that the information processing apparatus is currently connected to the external power supply and a remaining battery capacity is more than or equal to a predetermined value based on the information regarding the state of connection.

11. The information processing apparatus according to claim 1, wherein
the processing unit determines whether or not switching of the communication unit is possible based on information indicating a connectability to an external power supply.

12. The information processing apparatus according to claim 1, wherein
when the communication unit being used is to be switched to another communication unit based on a selection result, the processing unit notifies a user of whether or not switching is possible before switching the communication unit.

13. The information processing apparatus according to claim 1, wherein
the processing unit monitors an implementation status of a schedule item included in the schedule information and, when detecting information indicating that implementation of the schedule item has ended, selects the communication unit based on a next schedule of the ended schedule item.

14. An information processing method executed by a computer, the method comprising selecting one communication unit from a plurality of communication units having different communication schemes based on schedule information and time information.

15. A program for causing a computer to select one communication unit from a plurality of communication units having different communication schemes based on schedule information and time information.
